(19) United States
(12) Patent Application Publication
(10) Pub. No.: US 2006/0037081 A1
(43) Pub. Date: Feb. 16, 2006

(54) Method of and apparatus for controlling surveillance system resources

(75) Inventors: Scott Moses, Clovis, CA (US); Gerrit Hurenkamp, Madera, CA (US)

Correspondence Address: Paul T. Kashimba, Esq.;Gunster, Yoakley & Stewart, P.A., Suite 1400, 500 East Broward Boulevard, Fort Lauderdale, FL, 33394, US

(73) Assignee: Pelco

(21) Appl. No.: 10/918,183

(22) Filed: Aug. 13, 2004

(51) Int. Cl. H04L 9/32

(52) U.S. Cl. 726/27

(57) ABSTRACT

An apparatus for and method of assigning access to system resources comprising the steps of providing a set of system permissions to access the system resources, providing a role creation permission to allow a role having a role set of permissions from the set of system permissions to create a role having a set of permissions, which is a subset of the role set of permissions, creating a first role having a first set of permissions including a permission from the system permissions and a role creation permission, assigning a user to the first role, and allowing the user to create a second role having a second set of permissions which include only permissions from the first set of permissions.

### CROSS-REFERENCE TO RELATED APPLICATION

N/A

### STATEMENT REGARDING FEDERALLY SPONSORED RESEARCH OR DEVELOPMENT

N/A

### BACKGROUND OF THE INVENTION

This invention relates to surveillance systems and, in particular, to a system and method of controlling access to system resources in a surveillance system. As used herein the term surveillance system includes building management, access control, and security systems.

As surveillance systems have become more complex with the possibility that multiple personnel may be operating the surveillance system at the same time and that these personnel may be in different jobs or roles, there has arisen a need for simplifying the task of creating the appropriate roles and assigning the appropriate set of permissions to access system resources that are necessary to perform the job or role. In addition, it is necessary to have necessary controls in place so that the user assigned to the particular job or role does not have access to system resources that are not required by that job or role. Since there has been no mechanism available, the administrator of the system has been burdened with the task of meeting the demands of numerous departments to create roles and assign only the necessary permissions to the role. With today's rapid changes in organizations and job responsibilities, there is a need for a more efficient and flexible mechanism for creating roles and assigning access to the required system resources.

### SUMMARY OF THE INVENTION

In accordance with the present invention there is provided a method of assigning access to system resources comprising the steps of: providing a set of system permissions to access the system resources; providing a role creation permission to allow a role having a role set of permissions, which is a subset of the set of system permissions, to create a role having a set of permissions from the role set of permissions; creating a first role having a first set of permissions including a permission from the system permissions and a role creation permission; assigning a user to the first role; and allowing the user to create a second role having a second set of permissions which include only permissions from the first set of permissions.

There is also provided in accordance with the present invention a method of assigning access to system resources comprising the steps of: providing a set of system permissions to access the system resources; providing a role creation permission to allow a role having a role set of permissions, which is a subset of the set of system permissions, to create a role having a set of permissions from the role set of permissions; creating a first role having a first set of permissions including a permission from the system permissions and the role creation permission; assigning a first user to the first role; creating a second role having a second set of permissions including a permission from the system permissions and the role creation permission; assigning a second user to the second role; and allowing the first and second users to create a third role having a third set of permissions which include only permissions from the first and second sets of permissions. The subject method may further comprise the steps of providing a co-parent permission, determining if a role has the co-parenting permission, and not allowing a role to be a co-parent if the role does not have the co-parenting permission.

In addition, the present invention provides an apparatus for assigning access to system resources in a networked system comprising: a plurality of resources connected to a network; memory for storing a set of system permissions to access the video surveillance resources, a role creation permission to allow a role having a role set of permissions from the set of system permissions to create a role having a set of permissions from the role set of permissions, and a first role having a first set of permissions including a permission from the set of system permissions and the role creation permission; and a processor in communication with the memory for allowing a request to assign a first user to the first role and for allowing the first user to create a second role having a second set of permissions provided that the second set of permissions includes only permissions from the first set of permissions.

Still further, the present invention provides an apparatus for assigning access to system resources in a networked system comprising: a plurality of resources connected to a network; memory for storing a set of system permissions to access the video surveillance resources, a role creation permission to allow a role having a role set of permissions from the set of system permissions to create a role having a set of permissions from the role set of permissions, a first role having a first set of permissions including a permission from the set of system permissions, and a second role having a second set of permissions including a permission from the set of system permissions; and a processor in communication with the memory for allowing a request to assign a first user to the first role and a second user to the second role and for allowing the first user and the second user to create a third role having a third set of permissions provided that the third set of permissions includes only permissions from the first and second sets of permissions. In the subject apparatus, the memory may also store a co-parenting permission, and the processor determines if a role has the co-parenting permission and does not allow a role to be a co-parent if the role does not have the co-parenting permission.

The apparatus and method of the present invention provide a flexible and efficient way to manage the creation of roles and the assignment of permissions to utilize system assets even in a large distributed system. The subject invention also ensures that improper roles are not created.

Other advantages and applications of the present invention will be made apparent by the following detailed description of the preferred embodiment of the invention.

### BRIEF DESCRIPTION OF THE SEVERAL VIEWS OF THE DRAWINGS

FIG. 1 is a block diagram of a video surveillance system utilizing the present invention.

FIG. 2 is a role tree block diagram illustrating an aspect of the present invention.

FIG. 3 is a role tree block diagram illustrating an aspect of the present invention.

FIG. 4 is a role tree block diagram illustrating an aspect of the present invention.

FIG. 5 is a role tree block diagram illustrating an aspect of the present invention.

FIG. 6 is a flowchart of the system process of the present invention.

FIG. 7 is a flowchart of the system process of the present invention.

### DETAILED DESCRIPTION OF THE INVENTION

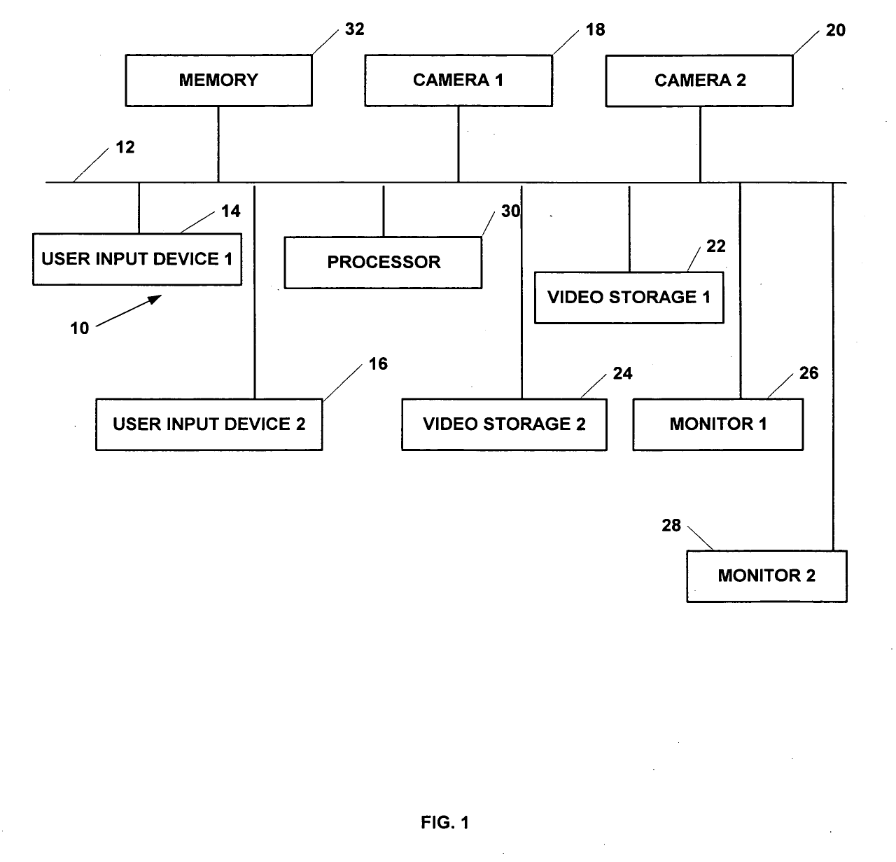

Referring to FIG. 1, a video surveillance system incorporating the present invention is shown generally by numeral 10. A network 12, which can be a hard-wired closed network, local area network, or wide area network such as the Internet, connects the various parts and resources of video surveillance system 10. User input devices 14 and 16 are connected to network 12 and can be a controller, keyboard, mouse, biometric reader, identification card or identification device, laptop or desktop computer or workstation connected to the network, or other suitable input device. User input devices 14 and 16 can be used to control the pan, tilt, and zoom functions of cameras 18 and 20 as is known in the art. Video surveillance system 10 may also have video storage devices 22 and 24, which can be videocassette recorders or digital video recorders, connected to network 12 to record video captured by cameras 18 and 20. The live video images from cameras 18 and 20 or prerecorded images from video storage devices 22 and 24 can be viewed on monitors 26 and 28. A processor 30 and memory 32, which can be disk drive storage or other suitable storage, are connected to network 12; processor 30 and memory 32 may be located anywhere in video surveillance system 10. The services available from each of the system resources, such as view, pan, tilt, zoom, and focus camera 18, are stored in memory 32. The system policies also reside in memory 32, as well as any roles created, the permission sets associated with those roles, and the users assigned to the respective roles. User input devices 14 and 16 can be used to input information into surveillance system 10 to create roles, assign permissions to use the system resources, and assign users to the respective roles, as discussed in detail below.

The system policies are based on roles and permission sets associated with those roles. A user accesses video surveillance system 10 through a user login by supplying a valid login name and associated password to the system by using input device 14 or 16. Once a user has logged into the system it is the role or roles to which the user has been assigned that determine which system resources the user can access. The role created by an administrator or other as described herein is stored in memory 32. Each role has its respective set of permissions to access system resources. The role's set of permissions provide the person in that role access to the necessary system resources to perform the job associated with the role, such as guard for building #1. Roles provide flexibility in an organization where people may change jobs or leave. If a person switches to a different job, he only needs to be assigned his new role and removed from the old role. If a person leaves the business, he is simply removed as a member of the role or roles he had been assigned. The roles do not change, only the set of people assigned to the roles change. In addition, roles can be easily modified by adding new permissions to system resources or removing permissions. Any user assigned to the role will then have the new permissions to access system resources.

For the purpose of role and user administration, all roles have some relationship with other roles. The role relationships supported by the system can be thought of as parent-child relationships. When a user role related permission is assigned to a role, that permission cannot be used unless the role is made a parent of another role. Once a parent-child relationship exists between two roles, a user assigned to the parent role may apply any role related service permissions of the role towards its role child.

Each role related service is limited to only the child roles of those roles granted permission to the service. For example, a configuration where two parent roles having exclusive sets of children have been defined as Role A, which has the permission to rename its child roles, and Role B, which does not have the permission to rename its child roles. If a user is assigned to both roles, he could only rename the child roles of Role A and not Role B. Even though the user was granted permission to a service allowing the renaming of child roles, application of that service can only be directed to children of the role through which the permission was granted, i.e., Role A.

A role can have any number of child roles, and a role can have any number of parent roles. However, not all roles can be made parents of other roles. The system policies stored in memory 30 prevent a role from becoming the parent of another role when a chain of one or more parent-child relationships loops back to a parent role in the chain. This prevents parent relationships from being established in cases where a role might be made a parent of itself, or where a role might be made a parent to a child role which in turn is made a parent to itself and so on. This restriction prevents the accidental granting of permissions through grandchild relationships and prevents the system from becoming too complicated to administer and comprehend.

All roles must have at least one parent role, except the administrator role. When a role is created, a parent must be specified for the creation process so that all roles have at least one parent role with permission to apply role related operations.

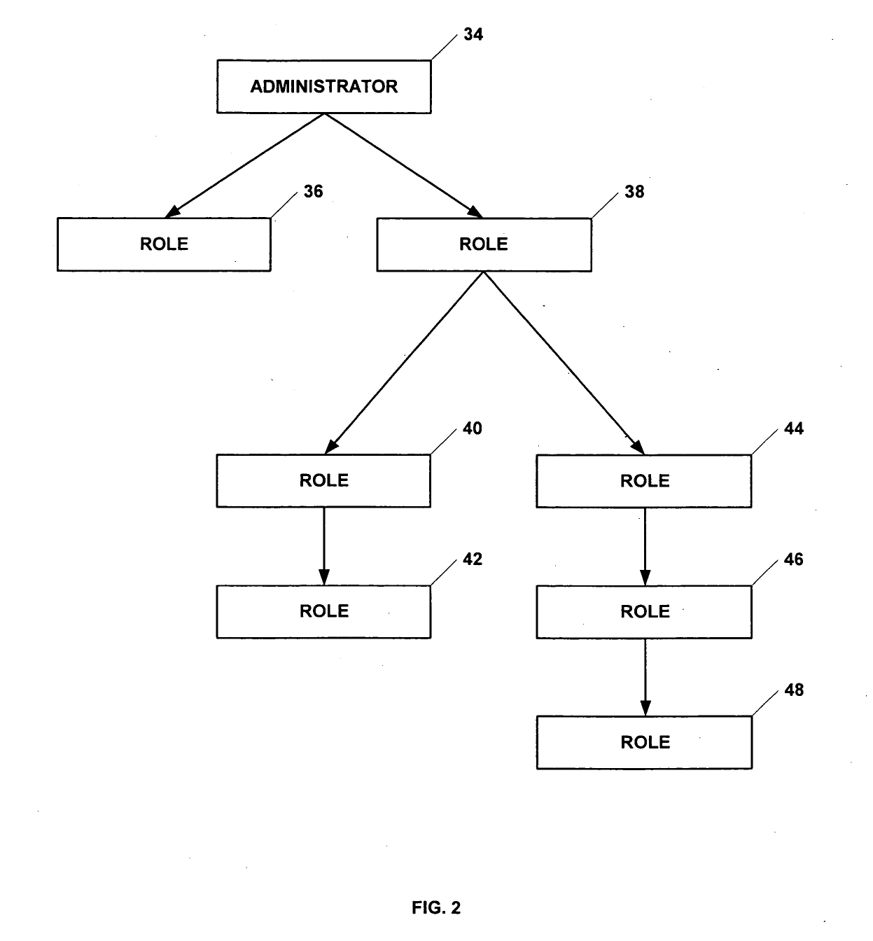

When a parent role is given a new permission, the parent role can apply the new permission to the role's children and descendents if desired. For example, with reference to FIG. 2, an Administrator 34 creates Role 36 and Role 38. A user assigned to Role 38 creates Role 40; a user assigned to Role 40 then creates Role 42. The user in Role 38 also creates Role 44; a user assigned to Role 44 then creates Role 46. A user assigned to Role 46 creates Role 48. From this tree of role creations it can be seen that if Role 36 is given a new permission to access a system resource, it cannot be passed on to any other role. If Role 38 is given a new permission to access a system resource, this new permission can be passed on to Role 40 and Role 44 if desired. If the user assigned to Role 38 only passes the new permission on to Role 40, then only Role 42 is eligible for receiving the new permission.

FIG. 2 also illustrates the relationships between roles. For example, Role 44 has ancestors Administrator 34 and Role 38. Role 46 and Role 48 are descendants of Role 44. Role 36, Role 40, and Role 42 have no relationship to Role 44.

Role 38 has a permission set that consists of permissions to access system resources, such as camera 18 in FIG. 1. If Role 38 has the permission to create other roles, then when the user assigned to Role 38 attempts to create Role 40, processor 30 in FIG. 1 consults memory 32 to determine if Role 38 has the permission to create other roles and verifies that Role 38 can create additional roles. The user assigned to Role 38 can assign Role 40 access to any system resources that are in the permission set of Role 38 and the permission to create additional roles. Processor 30 verifies that the role permission set for Role 40 includes only permissions included in the permission set for Role 38. The same process would be repeated for the creation of the roles indicated by numerals 42-48.

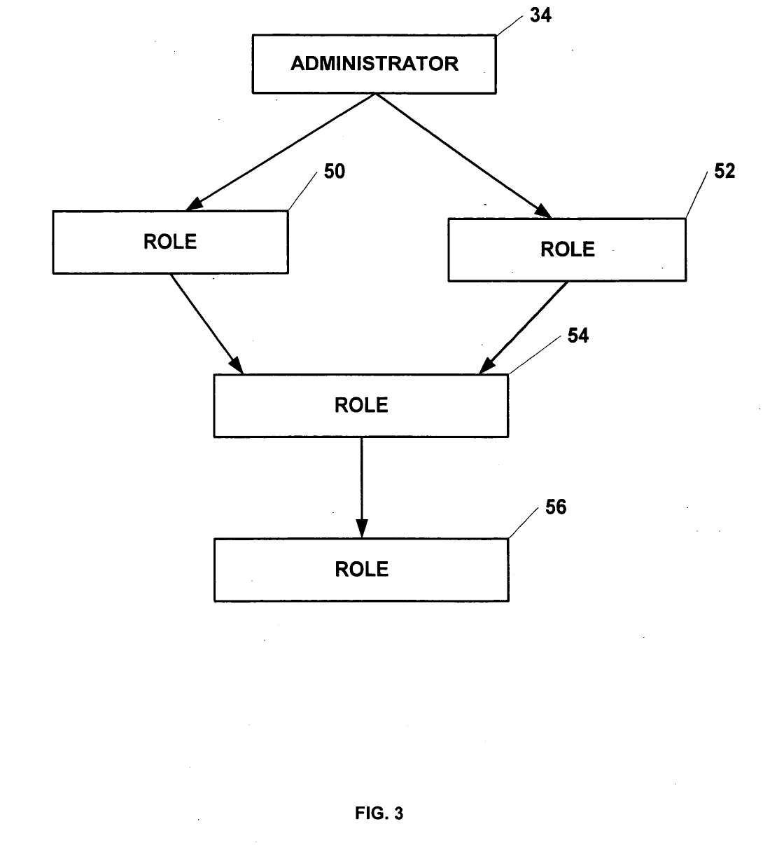

With reference to FIG. 3, the creation of a new role by users assigned to two existing roles is illustrated. Administrator 34 creates Role 50 with a first set of permissions and Role 52 with a second set of permissions. Administrator 34 can grant Roles 50 and 52 the permission to co-parent a new role so that users assigned to Role 50 and Role 52 can create Role 54 which has a third set of permissions that consists of permissions from the first and second sets of permissions. The permission to co-parent can be handled as a separate permission for setting the parent of roles, or it could be handled by the position of the roles within the role hierarchy. The advantage of making the co-parenting a separate permission is that someone in a role higher in the hierarchy could create a role hierarchy and ensure that the hierarchy stays as first created by not granting the ability to set co-parents.

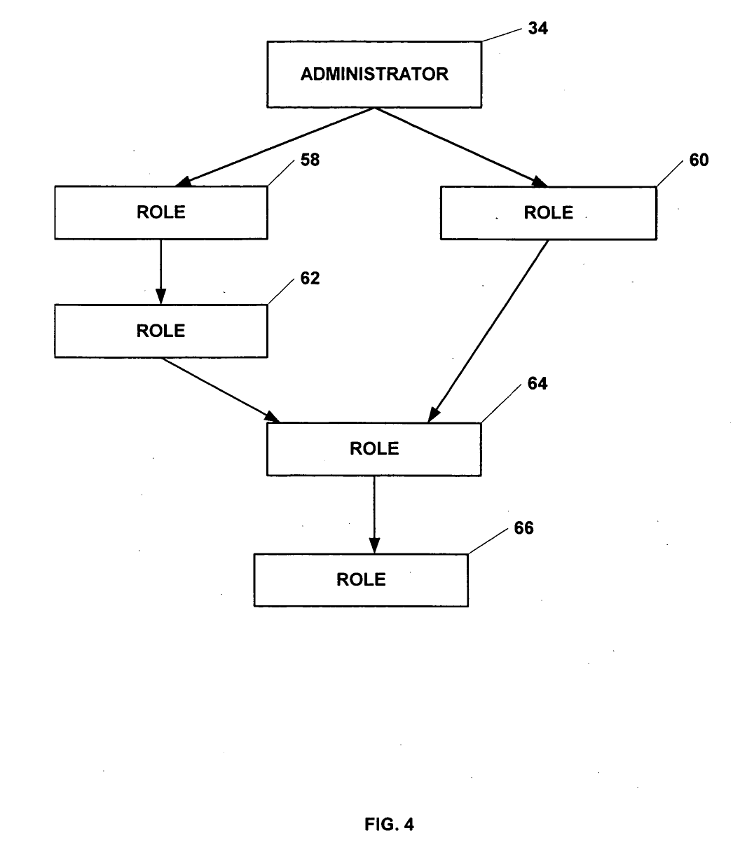

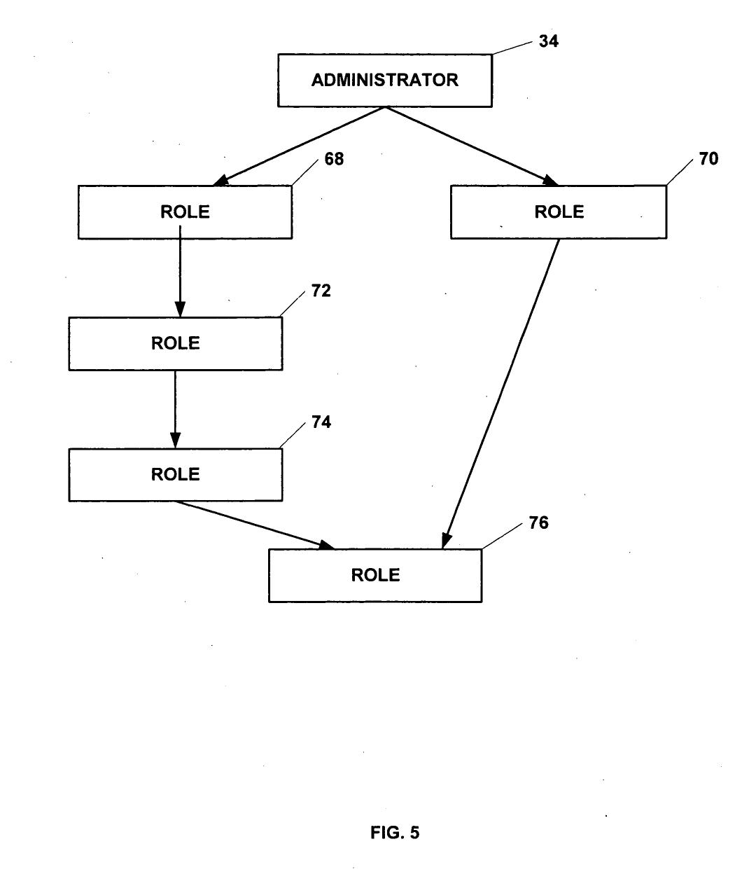

FIG. 4 illustrates the role creation tree where Administrator 34 creates Roles 58 and 60 with both roles having the permission to co-parent. A user assigned to Role 58 creates a Role 62 with the permission to co-parent. Users assigned to Role 60 and Role 62 then create a new Role 64. A user assigned to Role 64 can create a Role 66. Role 62 has a set of permissions that can consist of only the permissions in the permissions set of Role 58. Role 64 has a set of permissions that can consist only of the permissions in the permission sets of Role 60 or 62. Role 66 can only have permissions that are in the set of permissions for Role 64. FIG. 5 illustrates a similar tree where there are two levels, Role 72 and Role 74, between Role 68 and Role 76 before a new role is created by a descendant of Role 68 with Role 70.

When the system is first installed, only the administrator role is defined, and the user in the administrator role is the user that creates the initial roles and users for the system. Any new role created by the administrator can be given as many permissions as the administrator has, which is the entire permission set for the system resources as discussed in relation to FIG. 1. In turn, each role can assign as many or as few of its permissions as is necessary for the permissions set of its child.

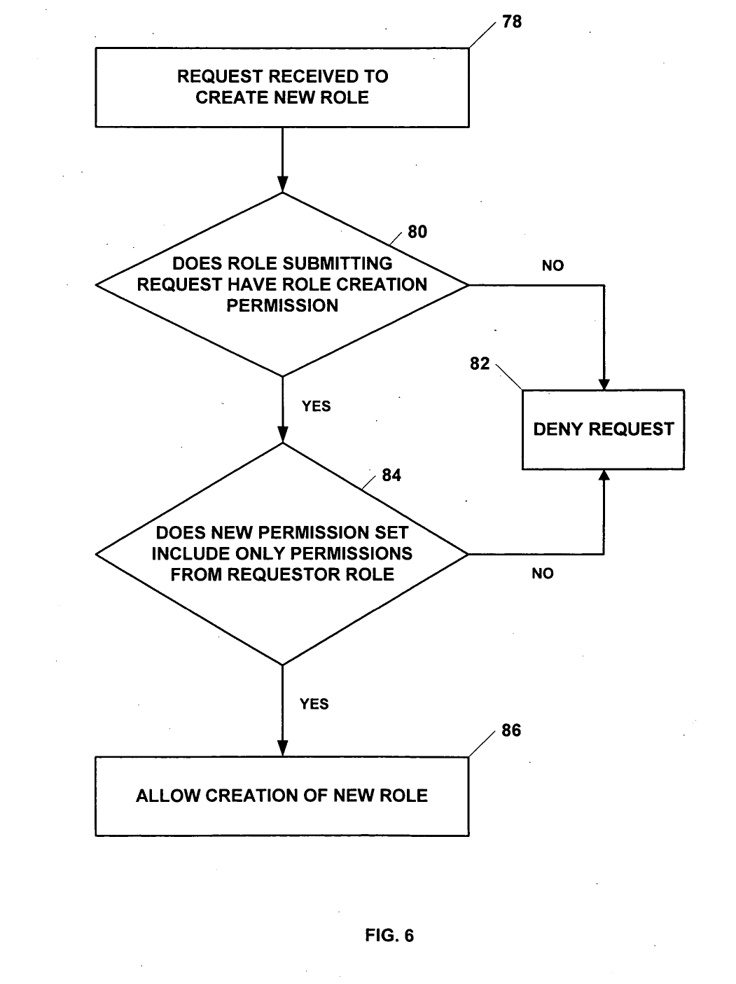

FIG. 6 illustrates the process that the system undertakes when a request to create a role is received from a user. At block 78 a request is received to create a new role. At decision point 80, the system determines whether the role requesting to create a new role has the role creation permission. If the requesting role does not have the permission to create roles, then the request is denied at block 82. If the requesting role has the necessary role creation permission, then at decision point 84, the system processor determines if the permission set in the new role includes only permissions that are in the permission set of the requesting role. If the new permission set includes permissions to access system resources that are not in the permission set of the requesting role, then the request is denied at block 82. If the permission set for new role contains only permissions to access system resources that are in the permission set of the requesting role, then the creation of the new role is allowed at block 86.

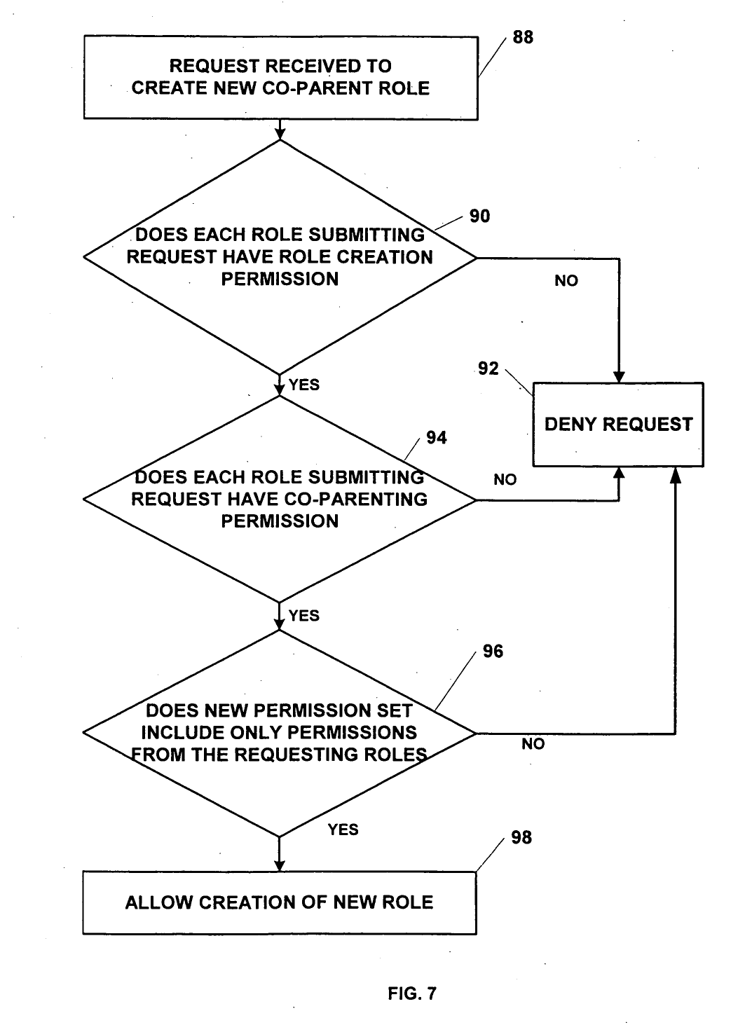

FIG. 7 illustrates the process that the system undertakes when a request to create a role is received from two or more users and the system has the co-parenting permission requirement. At block 88 a request is received to create a new co-parent role. At decision point 90, the system determines whether the roles requesting to create a new co-parent role have the role creation permission. If any of the requesting roles do not have the permission to create roles, then the request is denied at block 92. At decision point 94, the system determines whether the roles requesting to create a new co-parent role have the co-parenting permission. If any of the requesting roles do not have the co-parenting permission, then the request is denied at block 92. At decision point 96, the system processor determines if the permission set in the new role includes only permissions that are in the permission sets of the requesting roles. If the new permission set includes permissions to access system resources that are not in the permission sets of any of the requesting roles, then the request is denied at block 92. If the permission set for new co-parent role contains only permissions to access system resources that are in the permission sets of the requesting roles, then the creation of the new role is allowed at block 98.

It is to be understood that variations and modifications of the present invention can be made without departing from the scope of the invention. It is also to be understood that the scope of the invention is not to be interpreted as limited to the specific embodiments disclosed herein, but only in accordance with the appended claims when read in light of the foregoing disclosure.

What is claimed is:

1. A method of assigning access to system resources comprising the steps of: providing a set of system permissions to access the system resources; providing a role creation permission to allow a role having a role set of permissions, which is a subset of the set of system permissions, to create a role having a set of permissions from the role set of permissions; creating a first role having a first set of permissions including a permission from the system permissions and a role creation permission; assigning a user to the first role; and allowing the user to create a second role having a second set of permissions which include only permissions from the first set of permissions.

2. A method as recited in claim 1, further comprising the steps of determining if a role has the parenting permission and not allowing a user assigned to a role to create another role if the role to which the user is assigned does not have the parenting permission.

3. A method as recited in claim 2, further comprising the steps of assigning a user to the second role, wherein the second set of permissions includes the role creation permission; and allowing the user in the second role to create a third role having a third set of permissions which include only permissions from the second set of permissions.

4. A method as recited in claim 3 further comprising the step of verifying that a role created by a role does not loop back in the chain role creation relationship.

5. A method of assigning access to system resources comprising the steps of: providing a set of system permissions to access the system resources; providing a role creation permission to allow a role having a role set of permissions, which is a subset of the set of system permissions, to create a role having a set of permissions from the role set of permissions; creating a first role having a first set of permissions including a permission from the system permissions and the role creation permission; assigning a first user to the first role; creating a second role having a second set of permissions including a permission from the system permissions and the role creation permission; assigning a second user to the second role; and allowing the first and second users to create a third role having a third set of permissions which include only permissions from the first and second sets of permissions.

6. A method as recited in claim 5, further comprising the steps of determining if a role has the parenting permission, and not allowing a user assigned to a role to create another role if the role to which the user is assigned does not have the parenting permission.

7. A method as recited in claim 6, further comprising the steps of providing a co-parent permission, determining if a role has the co-parenting permission, and not allowing a role to be a co-parent if the role does not have the co-parenting permission.

8. A method as recited in claim 7, further comprising the steps of assigning a third user to the third role, wherein the third set of permissions includes the role creation permission, and allowing the third user in the third role to create a fourth role having a fourth set of permissions which include only permissions from the third set of permissions.

9. A method as recited in claim 8, further comprising the step of verifying that a role created by a role does not loop back in the chain role creation relationship.

10. A method as recited in claim 5, further comprising the steps of assigning a third user to the third role, creating a fourth role having a fourth set of permissions including a permission from the system permissions and the role creation permission, assigning a fourth user to the fourth role, and allowing the third user and fourth user to create a fifth role having a set of permissions that include only permissions in the third and fourth permission sets.

11. An apparatus for assigning access to system resources in a networked system comprising: a plurality of resources connected to a network; memory for storing a set of system permissions to access said plurality of resources, a role creation permission to allow a role having a role set of permissions from the set of system permissions to create a role having a set of permissions from the role set of permissions, and a first role having a first set of permissions including a permission from said set of system permissions and said role creation permission; and a processor in communication with said memory for allowing a request to assign a first user to said first role and for allowing said first user to create a second role having a second set of permissions provided that said first role has said role creation permission and said second set of permissions includes only permissions from said first set of permissions.

12. An apparatus as recited in claim 11, wherein said processor allows a request to assign a second user to said second role and wherein said processor allows said second user to create a third role having a third set of permissions provided that said second role has said role creation permission and provided that said third set of permissions includes only permissions from said second set of permissions.

13. An apparatus as recited in claim 12, wherein said processor verifies that a role created by a role does not loop back in the chain role creation relationship.

14. An apparatus as recited in claim 11, wherein said networked system comprises a video surveillance system and said plurality of resources comprises video surveillance resources.

15. An apparatus for assigning access to system resources in a networked system comprising: a plurality of resources connected to a network; memory for storing a set of system permissions to access said plurality of resources, a role creation permission to allow a role having a role set of permissions from the set of system permissions to create a role having a set of permissions from the role set of permissions, a first role having a first set of permissions including a permission from said set of system permissions, and a second role having a second set of permissions including a permission from said set of system permissions; and a processor in communication with said memory for allowing a request to assign a first user to said first role and a second user to said second role and for allowing said first user and said second user to create a third role having a third set of permissions provided said first and second users have said role creation permission and that said third set of permissions includes only permissions from said first and second sets of permissions.

16. An apparatus as recited in claim 15, wherein said memory stores a co-parent permission, and said processor determines if a role has the co-parenting permission and does not allow a role to be a co-parent if the role does not have the co-parenting permission.

17. An apparatus as recited in claim 16, wherein said processor allows a request to assign a third user to said third role, wherein the third set of permissions includes the role creation permission, and allows the third user in the third role to create a fourth role having a fourth set of permissions which include only permissions from the third set of permissions.

18. An apparatus as recited in claim 17, wherein said processor verifies that a role created by a role does not loop back in the chain role creation relationship.

19. An apparatus as recited in claim 15, wherein said networked system comprises a video surveillance system and said plurality of resources comprises video surveillance resources.
